(19) United States
(12) Patent Application Publication
(10) Pub. No.: US 2025/0377632 A1
(43) Pub. Date: Dec. 11, 2025

(54) MOON PHASE AND EARTH PHASE DISPLAY DEVICE FOR A HOROLOGICAL MOVEMENT

(71) Applicant: ETA SA MANUFACTURE HORLOGÈRE SUISSE, Grenchen (CH)

(72) Inventors: Ivan VILLAR, Brügg (CH); Raphaël COURVOISIER, Corcelles (CH)

(73) Assignee: ETA SA MANUFACTURE HORLOGÈRE SUISSE, Grenchen (CH)

(21) Appl. No.: 19/203,361

(22) Filed: May 9, 2025

(30) Foreign Application Priority Data
Jun. 5, 2024 (EP) 24180117.4

(51) Int. Cl. G04B 19/26; G04B 13/02

(52) U.S. Cl. CPC G04B 19/268; G04B 13/027

(57) ABSTRACT

A Moon phase and Earth phase display device (100) for a horological movement, which display device includes a dial (130) on which is arranged a plurality of graphical representations (112) symbolizing respectively different successive phases of a celestial body, said display device (100) further including a drive mechanism (140) configured to move a display (110), the display (110) including at least two indicator members (111) of different appearances, configured to symbolise the Moon and the Earth respectively, so that the position of the indicator members (111) relative to the graphical representations (112) represents a Moon phase indication and an Earth phase indication respectively.

### CROSS REFERENCE TO RELATED APPLICATIONS

This application claims priority to European Patent Application No. 24180117.4, filed on Jun. 5, 2024, the disclosures of which are incorporated by reference herein their entireties

### TECHNICAL FIELD OF THE INVENTION

The invention relates to the field of watchmaking and in particular to devices for displaying a time variable on a timepiece.

More particularly, the invention relates to a device for displaying a Moon phase and an Earth phase for a horological movement of a watch.

### TECHNOLOGICAL BACKGROUND

Moon phase displays are well known in the watchmaking industry, as are Earth phase displays, i.e. the display of the part of the Earth visible from the Moon.

Moon or Earth phase display devices add considerable complexity to the horological movement in which they are integrated.

Moreover, for aesthetic reasons, concomitant display of the Moon and Earth phases may be desired.

The invention meets this need, while simplifying as far as possible the kinematics for simultaneously displaying the phases of the Moon and Earth.

### SUMMARY OF THE INVENTION

To this end, the invention relates to a Moon phase and Earth phase display device for a horological movement. The display device comprises a dial on which is arranged a plurality of graphical representations symbolizing respectively different successive phases of a celestial body. The display device further comprises a drive mechanism configured to move a display, the display comprising at least two indicator members of different appearances configured to symbolise the Moon and the Earth respectively, so that the position of the indicator members relative to the graphical representations represents a Moon phase indication and an Earth phase indication respectively.

In particular embodiments, the invention can further include one or more of the following features, which must be considered singly or according to any combination technically possible.

In particular embodiments, the indicator members take the form of a hand and the graphical representations are evenly distributed around the periphery of the dial.

In particular embodiments, the display comprises at least two indicator members in the form of hands arranged in the continuation of each other so as to form a straight angle.

In particular embodiments, the display comprises a plurality of teeth via which it is intended to be moved by the drive mechanism at a rate of one step per day.

In particular embodiments, the drive mechanism comprises an hour wheel of a motion-work train, to which a drive wheel is kinematically connected via a train of intermediate wheels, the drive wheel being intended to cooperate, by means of a driving finger-piece which it carries, with the transmission wheel.

In particular embodiments, the display device comprises a correction mechanism provided with a control member configured to be kinematically linked with a corrector via a train of intermediate wheels.

The present invention further relates to a watch comprising a horological movement provided with a device for displaying a Moon phase and an Earth phase as described above.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a front view of a watch comprising a Moon phase and Earth phase display device according to one example embodiment of the invention,

FIG. 2 shows a perspective view of the watch in FIG. 1, in which components have been masked to reveal the display device.

It should be noted that the figures are not necessarily drawn to scale for reasons of clarity.

### DETAILED DESCRIPTION OF THE INVENTION

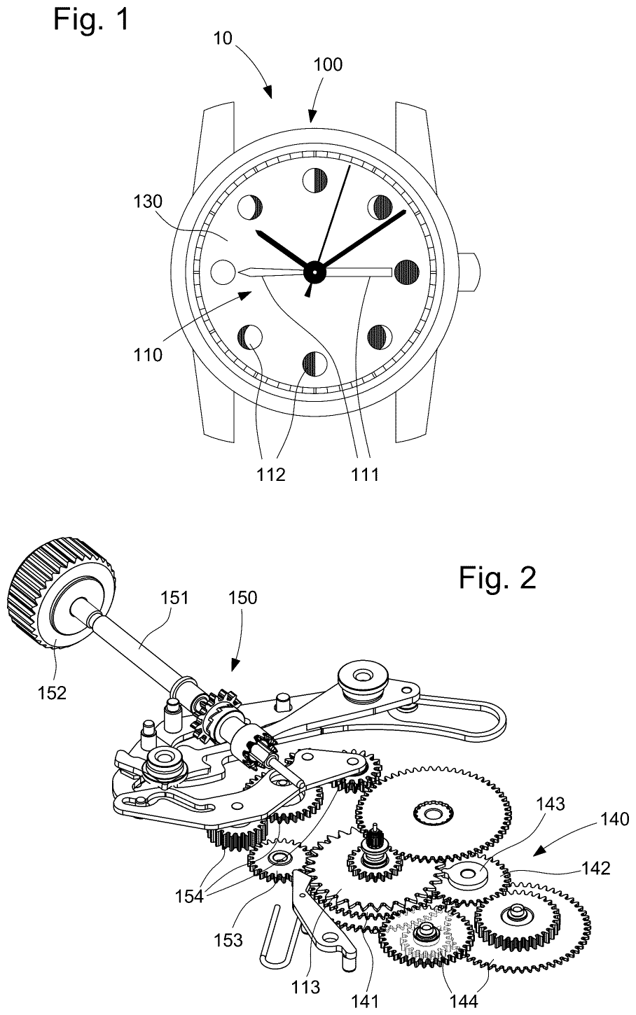

FIG. 1 shows a watch 10 in an example embodiment of the invention, which watch comprises a horological movement provided with a device 100 for displaying a Moon phase and an Earth phase.

The display device 100 includes a display 110 comprising at least two indicator members 111 of different appearances, configured to symbolise the Moon and the Earth respectively, as described in more detail below.

As can be seen in FIG. 1, the display device 100 further comprises a dial 130 on which is arranged a plurality of graphical representations 112 symbolizing respectively different successive phases of a celestial body. In particular, the dial 130 comprises at least four graphical representations 112 evenly distributed around its periphery, i.e. the graphical representations 112 are closer to the perimeter of the dial 130 than to its centre. In the example embodiment shown in FIG. 1, the dial 130 includes eight graphical representations 112. In the example embodiment shown in FIG. 1, two diametrically opposed graphical representations 112 symbolise opposing phases.

Thus, the position of the indicator members 111 relative to the graphical representations 112 represents a Moon phase indication and an Earth phase indication respectively.

In the example embodiment of the invention shown in FIG. 1, the indicator members 111 take the form of a hand. In order for each to have a different appearance from the other to symbolise the Moon and the Earth respectively, the indicator members 111 can have their own colour, for example one can be blue, symbolizing the Earth, and the other grey, symbolizing the Moon. More specifically, the indicator members 111 can each have a body, the free end whereof forms a point, the body and/or the point being decorated so that the indicator members 111 are different from one another.

In the example shown in FIG. 1, the indicator members 111 are arranged in the continuation of each other so as to form a straight angle. The hands are thus diametrically opposite each other in this example. More specifically, the frequency of appearance of Moon phases is identical to that of Earth phases, and the Moon and Earth phases are exactly opposite. In other words, when the surface of the Moon visible from the Earth decreases, the surface of the Earth visible from the Moon increases in identical proportions, and vice-versa. The dial 130 has an even number of graphical representations 112, so that the indicator members 111 are directed at the same time towards opposite graphical representations 112.

It is possible for the hands to constitute a single one-piece element or two separate elements that are stacked and rotate as one.

As shown in FIG. 1, the graphical representations 112 are arranged on the dial 130 so that they can be successively indicated by the indicating members 111. To this end, a drive mechanism 140, with which the display device 100 is equipped, is configured to move the display 110.

In the example embodiment shown in FIG. 2, the display 110 comprises a transmission wheel 113 via which it is intended to be moved by the drive mechanism 140 at a rate of one step per day. The transmission wheel 113 is rigidly connected to the indicator members 111, for example by means of a rod onto which said wheel and said members are driven, in a manner known to a person skilled in the art.

In order to move the display 110, the drive mechanism 140 preferably consists of a date drive mechanism. In particular, as shown in FIG. 2, the drive mechanism 140 comprises an hour wheel 141 of a motion-work train, rotated, for example, by two revolutions per day, in a manner known in the prior art. The drive mechanism 140 further comprises a drive wheel 142 kinematically connected to the hour wheel 141 by a train of intermediate wheels 144 in the example embodiment of the invention shown in FIG. 2. The drive wheel 142 is intended to cooperate with a toothing of the transmission wheel 113 of the display 110 via a driving finger-piece 143.

The transmission wheel 113 preferably has an even number of teeth, for example 28 or 30, in the example embodiment shown in the figures. In particular, so that the indicator members 111 are directed towards a graphical representation 112 at each step in the movement of the display 110, the transmission wheel 113 can have a number of teeth equal to the number of graphical representations 112. It is understood in this case that the display 110 is driven in sequential movement in the example embodiment of the invention shown in FIG. 2. However, the display can be driven continuously by replacing the driving finger-piece 143 with a toothed wheel meshing with the transmission wheel 113. In such a case, the transmission wheel 113 has a suitable number of teeth, for example between forty and sixty, which can be calculated by a person skilled in the art.

Conventionally, the stability of the position of the display 110 is guaranteed by a jumper cooperating with the teeth of the transmission wheel 113, as shown in FIG. 2.

Advantageously, the display device 100 can comprise a correction mechanism 150 provided with a control member formed, in the example embodiment of the invention shown in the figures, by a winding stem 151 linked to a winding button 152. The winding stem 151 is configured to be kinematically linked to a corrector 153 by means of a train of intermediate wheels 154. Such a correction mechanism 150 is shown in the figures but is not described in detail in the text because it is well known as such to a person skilled in the art.

The present invention advantageously makes it possible to take advantage of an existing design of a watch with a date display. This is because, in order to be implemented, the invention requires minimal adaptation, only requiring the dial 130 and the display 110 of the watch 10 to be replaced. Moreover, thanks to the features of the invention, a fast date correction mechanism can be easily adapted to correct the Moon and Earth phases.

More generally, it should be noted that the implementations and embodiments considered above have been described by way of non-limiting examples, and that other alternatives are consequently possible.

It should be noted that, for reasons of clarity, the components of the horological movement known to a person skilled in the art are not described in this text and do not appear in the figures.

1. A moon phase and earth phase display device (100) for a horological movement, comprising:
a dial (130) on which is arranged a plurality of graphical representations (112) symbolizing respectively different successive phases of a celestial body;
a drive mechanism (140) configured to move a display (110), the display (110) comprising at least two indicator members (111) of different appearances, configured to symbolise the Moon and the Earth respectively, so that the position of the indicator members (111) relative to the graphical representations (112) represents a Moon phase indication and an Earth phase indication respectively.

2. The display device (100) according to claim 1, wherein the indicator members (111) take the form of a hand and the graphical representations (112) are evenly distributed around the periphery of the dial (130).

3. The display device (100) according to claim 1, wherein the display (110) comprises at least two indicator members (111) in the form of hands arranged in the continuation of each other so as to form a straight angle.

4. The display device (100) according to claim 1, wherein the display (110) comprises a transmission wheel (113) via which it is intended to be moved by the drive mechanism (140) at a rate of one step per day.

5. The display device (100) according to claim 4, wherein the drive mechanism (140) comprises an hour wheel (141) of a motion-work train, to which a drive wheel (142) is kinematically connected via a train of intermediate wheels (144), the drive wheel (142) being intended to cooperate, by means of a driving finger-piece (143) which it carries, with the transmission wheel (113).

6. The display device (100) according to claim 1, comprising a correction mechanism (150) provided with a control member configured to be kinematically linked with a corrector (153) via a train of intermediate wheels (154).

7. A watch (10) comprising a horological movement provided with the Moon phase and Earth phase display device (100) according to claim 1.
